(19) United States
(12) Patent Application Publication
(10) Pub. No.: US 2019/0136855 A1
(43) Pub. Date: May 9, 2019

(54) Pump Housing

(71) Applicant: Continental Automotive GmbH, Hannover (DE)

(72) Inventor: Eyk Heinemann, Cham (DE)

(73) Assignee: Continental Automotive GmbH, Hannover (DE)

(21) Appl. No.: 16/094,302

(22) PCT Filed: Apr. 12, 2017
(86) PCT No.: PCT/EP2017/058863

§ 371 Date: Oct. 17, 2018

(30) Foreign Application Priority Data
Apr. 18, 2016 (DE) 10 2016 206 456.8

(51) Int. Cl. F04B 53/16; F16B 5/02; F16B 31/02; F04B 53/22; F02M 59/02; F02M 59/48; F16K 27/00

(52) U.S. Cl. CPC F04B 53/16; F16B 5/02; F16B 31/02; F02M 2200/855; F02M 59/025; F02M 59/48; F16K 27/00; F04B 53/22

(57) ABSTRACT

Various embodiments include an assembly comprising: a housing; a flange having a first and second flange side; a collar extending into a connector opening of the flange; and a depression running around the assembly opening on the first flange side. The flange has a first assembly opening spaced from the connector opening. The depression includes an inner periphery running laterally along an entire circumference of the first flange side spaced from the assembly opening.

### CROSS-REFERENCE TO RELATED APPLICATIONS

This application is a U.S. National Stage Application of International Application No. PCT/EP2017/058863 filed Apr. 12, 2017, which designates the United States of America, and claims priority to DE Application No. 10 2016 206 456.8 filed Apr. 18, 2016, the contents of which are hereby incorporated by reference in their entirety.

### TECHNICAL FIELD

The present disclosure relates to housings. Various embodiments may include a combination comprising a housing and a flange, for example a pump housing.

### BACKGROUND

Typically, a housing for a high-pressure gasoline or diesel pump (for example a single-piston pump) includes at least one flange. In the axial fixing of single-piston pumps as well as of servo valves to a further housing (for example to the housing of a cylinder head on an engine) it is the intention to prevent tilting with the aid of the flange. For example, the flange is welded to the pump housing or servo housing, and is fastened to the engine housing by means of two screws. Since the screws can absorb and receive forces largely in only one direction, tilting and axial lifting can arise, this being potentially damaging to the kinematic sequences (for example, to the axial movement of a valve piston or pump piston) in the interior of the system to be fastened.

Therefore, pre-tensioned fixing flanges are used in practice which by means of the pre-tensioning forces are intended to prevent any lateral tilting and any axial lifting by virtue of the reactive force when the medium (for example, fuel) to be compressed is being compressed. In order for the pre-tensioning to be generated on the flange, the two outer sides of the flange are pulled down by tightening the two screws, while the flange in the interior region is fixedly connected to the pump housing by way of a circular weld, for example. A support face which has an axial offset in relation to the lower side of the flange in the non-braced state is located on the pump housing. When the two sides of the flange are braced by means of the screws, the flange sides, on account of deformation, move in the screw-fitting direction, and an incline which unilaterally stresses the screw head in a non-symmetrical manner is created. The tensions generated on account thereof can lead to a failure of the screw head and to the latter being torn off. This risk increases as the flange pre-tensioning increases, and in the case of wide screw heads.

It has been attempted to date to solve this problem by delimiting the pre-tensioning and the tilting of the flange outer sides resulting therefrom, or by using high-strength screws having a smaller screw-head contact area. It has also been attempted to minimize a unilateral, non-symmetrical introduction of force by means of additional passage openings that are incorporated in the flange. However, attention has to be paid herein to a reduction of the flange stiffness under the more highly stressed side of the screw head.

### SUMMARY

Some embodiments of the teachings herein include a combination (1) comprising a housing (2) and a flange (3), the latter having a first flange side (4) and opposite thereto a second flange side (5), wherein the combination (1) comprises a collar (6) which either is part of the housing (2) or is fastened to the housing (2), wherein the collar (6) is inserted in a connector opening (7) of the flange (3), wherein the flange (3) has at least one first assembly opening (8) which is configured so as to have a spacing from the connector opening (7), characterized in that a depression that runs about the at least one assembly opening (8) is configured in the flange (3) on the first flange side (4), wherein the depression (34) has an inner periphery (35) which along the entire circumference of the latter runs laterally so as to have a spacing (x) from the assembly opening (8).

In some embodiments, the flange (3) has at least one second assembly opening (8) which is configured so as to be spaced apart from the connector opening (7), wherein the connector opening (7) is configured between the first assembly opening (8) and the second assembly opening (8), and in that a depression (34) that runs about the second assembly opening (8) is configured in the flange (3) on the first flange side (4), wherein the depression (34) has an inner periphery (35) which along the entire circumference of the latter runs laterally so as to have a spacing (x) from the assembly opening (8).

In some embodiments, the depression (34) is configured as an annular, in particular circular, groove (34′).

In some embodiments, the depth of the depression (34) is uniform in the entire depression (34), wherein the depth is in particular in the range from 0.1 mm to 0.5 mm, and may be 0.3 mm.

In some embodiments, the width of the depression (34) is uniform in the entire depression (34).

In some embodiments, the assembly opening (8) has a first peripheral portion (9) that is contiguous to a first flange surface region (10) on the first flange side (4), and a second peripheral portion (11) that in comparison to its first peripheral portion (9) lies closer to the connector opening (7), a second flange surface region (12) on the first flange side (4) being contiguous to said second peripheral portion (11), wherein the first flange surface region (10) and the second flange surface region (12) on the external side thereof are bordered by the depression (34), wherein on the second flange side (5) a periphery (14) of the connector opening (7), and/or a surface region (15) of the flange (3) that is adjacent, in particular contiguous, to the connector opening (7), define(s) a geometric reference plane (E), and wherein the first flange surface region (10) in comparison to the second flange surface region (12) in a direction perpendicular to the reference plane (E) is more remote from the latter.

In some embodiments, the combination (1) comprises at least two screws (19), wherein in a use state in which in each case one screw (19), proceeding from the first flange side (4), is inserted into in each case one of the two assembly openings (8), on each screw (19), when viewed in a vertical projection of the screw head (28) thereof onto the flange (3), the screw head (28) thereof, in particular along the entire circumference thereof, projects radially outward beyond the inner periphery (35) of the depression (34), and the outer periphery (36) of the depression (34), in particular along the entire circumference thereof, runs radially outside the screw head (28).

In some embodiments, the connector opening (7) in terms of a direction of longitudinal extent (L) of the flange (3) is configured so as to be, in particular centric, between the two assembly openings (8), wherein in particular the respective longitudinal central axes of the connector opening (7) and of the two assembly openings (8) collectively intersect a geometric longitudinal center line (20).

In some embodiments, the collar (6) is inserted in the connector opening (7) such that a collar longitudinal end (16) of the collar (6) on the second flange side (5) in a direction perpendicular to the reference plane (E) projects from the connector opening (7) beyond said reference plane (E).

In some embodiments, the collar (6) is press-fitted into the connector opening (7) and/or is welded to the flange (3), in particular by means of a laser welding method or a capacitor discharge welding method.

In some embodiments, the quantitative difference, in particular the largest quantitative difference, that arises between the spacing of the first flange surface region (10) from the reference plane (E) in a direction perpendicular to the latter, on the one hand, and the spacing of the second flange surface region (12) from the reference plane (E) in a direction perpendicular to the latter is smaller than or equal to the spacing of an end face (17) of the collar longitudinal end (16) and the reference plane (E) in a direction perpendicular to the latter.

In some embodiments, the housing (18) is a housing (18) of a single-piston pump which in particular is a high-pressure fuel injection pump, or a housing (18) of a servo valve.

In some embodiments, the first flange surface region (10) and the second flange surface region (12) extend so as to be parallel with the geometric reference plane (E).

In some embodiments, the first flange surface region (10) extends so as to be parallel with or inclined to the geometric reference plane (E), and in that the second flange surface region (12), in particular configured so as to be planar or curved, extends to as to be inclined to the geometric reference plane (E), wherein the spacing of the second flange surface region (12) from the reference plane (E) in a direction perpendicular to the latter, when viewed in a direction parallel to the direction of longitudinal extent (L), decreases as the distance from the connector opening (7) decreases, wherein in particular a peripheral portion of the second flange surface region (12) runs along a circular line.

In some embodiments, the surface of the flange (3) on the second flange side (5), at least between the connector opening (7) and the assembly opening (8) or the assembly openings (8), extends so as to be parallel with the reference plane (E).

In some embodiments, in each case one clearance (30) is configured in the flange (3) between the connector opening (7) and in each case one assembly opening (8).

As another example, some embodiments include an assembly (23) comprising a combination (1) as described above, wherein the assembly (23) comprises a housing (18), in particular a cylinder head housing of an engine, which has an in particular planar fastening surface (21) for fastening the combination (1), wherein, proceeding from the fastening surface (21), an insertion opening (24) and at least one first assembly bore (25) extend into the housing (18), wherein the collar longitudinal end (16) is supported on a region of the fastening surface (21) that is adjacent to the insertion opening (24), wherein a screw (19) is guided through the first assembly opening (8) and the at least one assembly bore (25), wherein the flange (3) is screw-fitted to the housing (18) by means of the screw (19), and wherein the screw (19) is tightened such that a first flange region (26) in which the first assembly opening (8) is configured contacts the fastening surface (21) and in particular is compressed against the latter.

In some embodiments, proceeding from the fastening surface (21), at least one second assembly bore (25) extends into the housing (18), in that a second screw (19) is guided through the second assembly opening (8) and the second assembly bore (25), wherein the flange (3) is screw-fitted to the housing (18) by means of the second screw (19), and wherein the second screw (19) is tightened such that a second flange region (26) in which the second assembly opening (8) is configured contacts the fastening surface (21) and in particular is compressed against the latter.

In some embodiments, the screw or the screws (19) has/have in each case one screw head (28), the contact region of the latter to the flange (3) lying completely in a flange surface region (37) of the flange (3) that is formed collectively by the first flange surface region (10) and the second flange surface region (12).

In some embodiments, the housing (2) protrudes into the insertion opening (24) of the housing (18).

### BRIEF DESCRIPTION OF THE DRAWINGS

The teachings of the present disclosure are described in more detail hereunder with reference to the appended figures which show exemplary embodiments. In the drawings:

FIG. 1 in a perspective manner shows a combination incorporating teachings of the present disclosure;

FIG. 2 shows a plan view of the combination shown in FIG. 1, in the viewing direction II in the latter;

FIG. 3 shows the combination in a sectional view along the section plane III-III in FIG. 2, wherein the combination is shown collectively with a housing fragment of an engine as a component part of an assembly incorporating teachings of the present disclosure prior to tightening the screws;

FIG. 3a shows an enlarged fragment of detail IIIa from FIG. 3;

FIG. 3b shows an enlarged fragment comparable to that of FIG. 3a, but relating to an assembled state after tightening the screws;

FIG. 4 shows an exploded view of the combination shown in the preceding figures;

FIG. 5 shows a plan view of the flange of the combination shown in the preceding figures, in the viewing direction V from FIG. 4;

FIG. 6 shows a sectional view along the section plane VI-VI in FIG. 5;

FIG. 6a shows an enlarged fragment of detail VIa from FIG. 6;

FIG. 7 in a plan view shows an alternative design embodiment of a flange incorporating teachings of the present disclosure;

FIG. 8 shows a sectional view along the section line VIII-VIII in FIG. 7;

FIG. 8a shows an enlarged fragment of detail VIIIa from FIG. 8;

FIG. 9 shows a sectional view of an assembly incorporating teachings of the present disclosure, said assembly comprising a combination prior to tightening the screws;

FIG. 9a shows an enlarged fragment of detail IXa from FIG. 9;

FIG. 9b shows an enlarged fragment comparable to that of FIG. 9a, but in an assembled state after tightening the screws;

FIG. 10 shows a plan view of the flange of the combination shown in FIG. 9;

FIG. 11 shows a sectional view along the section plane XI-XI in FIG. 10;

FIG. 11a shows an enlarged fragment of detail XIa from FIG. 11;

FIG. 12 in a sectional view shows a modification of the flange shown in FIG. 11;

FIG. 12a shows an enlarged fragment of detail XIIa from FIG. 12;

FIG. 13 in a plan view shows an embodiment of a flange for a combination incorporating teachings of the present disclosure;

FIG. 14 shows a sectional view along the section line XIV-XIV in FIG. 13;

FIG. 14a shows an enlarged fragment of detail XIVa from FIG. 14;

FIG. 15 in a sectional view shows a modification of the flange shown in FIG. 14;

FIG. 15a shows an enlarged fragment of detail XVa from FIG. 15;

FIG. 16 shows a sectional view of an assembly incorporating teachings of the present disclosure, said assembly comprising a combination prior to tightening the screws;

FIG. 16a shows an enlarged fragment of detail XVIa from FIG. 16;

FIG. 16b shows an enlarged fragment comparable to that of FIG. 16a, but relating to an assembled state after tightening the screws;

FIG. 17 shows a plan view of the flange of the combination shown in FIG. 16;

FIG. 18 shows a sectional view along the section line XVIII-XVIII in FIG. 17;

FIG. 18a shows an enlarged fragment of detail XVIIIa from FIG. 18;

FIG. 19 shows a plan view of a flange incorporating teachings of the present disclosure designed in a deviating manner;

FIG. 20 shows a sectional view along the section line XX-XX in FIG. 19; and

FIG. 20a shows an enlarged fragment of detail XXa from FIG. 20;

### DETAILED DESCRIPTION

The teachings of the present disclosure may be embodied in a combination of the type mentioned at the outset such that the mentioned disadvantages can be largely avoided. The intention is for an only unilateral contact between a screw head and the flange to be prevented. In some embodiments, contact is only established in a specific desired geometric region when the screw is being tightened, such that the loading of the screw can be set, in particular delimited. Furthermore, the contact region of the flange is enlarged and thus better secured against slippage.

In some embodiments, a depression that runs about the at least one assembly opening is configured in the flange on the first flange side, wherein the depression has an inner periphery which along the entire circumference of the latter runs laterally so as to have a spacing from the assembly opening. In some embodiments, there is an annular depression in the surface of the flange. The depression can be, for example, an embossed feature. The depression, depending on the design embodiment, may also be referred to as a pocket or as a groove. In some embodiments, the depression is sufficiently deep so as to prevent any contact with the screw head in the pre-tensioned state of the flange. The shoulder that is formed by the inner periphery of the depression in terms of the central axis of the screw is thus the outermost contact point between the screw head and the flange.

The inner periphery, in particular the internal diameter, of the depression thus determines the maximum “lever arm length” for transmitting pressure in the transition region between the screw head and the screw shank. The load generated by any tilting of the flange below a screw head can now be set in a targeted manner, or be reduced, if required, respectively, by way of the “lever arm length” which is determined by the inner periphery of the depression. In some embodiments, a sufficiently large residual bearing face for the screw head can be provided herein. The contact of the screw head can be set in a targeted manner to an optimum region by means of the depression. Any unilateral overload can thus be reduced. Any only unilateral contact between the screw head and the flange can be prevented. There is moreover the possibility for any contact to be enabled only in a specific desired geometric region, e.g. running about the assembly opening, and for the loading of the screw to thus be set in an optimal manner.

In some embodiments, there is an improved setting capability of the screw-head loading during tension-fitting of the combination, or in terms of tension-fitting a pump, respectively. This enables the use of more cost-effective screws of lower strength ratings and/or having wider screw heads. Moreover, this permits an increase in the pre-tensioning of the pump flange. The flange strength which is relevant to the pre-tensioning force of the assembly, is influenced to a significantly lesser extent than by the clearances in the flange to date which continue through the flange close to the screw head. There is nevertheless the possibility for providing depressions according to the invention and additional continuous clearances. The geometric faces can be incorporated in a cost-effective manner, for example by way of a downstream embossing process. Other shape-imparting processes such as, for example, a production by way of subtractive machining or the like, are also possible. The flange can be produced from sheet metal, for example, wherein other materials can also be considered, however.

In some embodiments, the flange may have at least one second assembly opening which is configured so as to have a spacing from the connector opening, wherein the connector opening is configured between the first assembly opening and the second assembly opening, and for a depression that runs about the second assembly opening to be configured in the flange on the first flange side, wherein the depression has an inner periphery which along the entire circumference of the latter runs laterally so as to have a spacing from the assembly opening. In some embodiments, the connector opening in terms of a direction of longitudinal extent of the flange to be configured so as to be, in particular centric, between the two assembly openings, wherein in particular the respective longitudinal central axes of the connector opening and of the two assembly openings collectively intersect a geometric longitudinal center line. This facilitates a uniform distribution of load when pre-tensioning. Further features pertaining may be configured either optionally on one flange region that is assigned to an assembly opening, or on two or a plurality of flange regions that are in each case assigned to one assembly opening.

In some embodiments, the depression is on the entire circumference that leads about the assembly opening. There is the possibility for the depression to be configured as an annular, in particular as a circular annular, groove. In some embodiments, the depth of the depression may be uniform in the entire depression, wherein the depth is in particular in the range from 0.1 mm to 0.5 mm, e.g. 0.3 mm. In some embodiments, the width of the depression to be uniform in the entire depression.

In some embodiments, the distribution of the compressive stress may be influenced, e.g. for a reduction of the maximum stress that would otherwise arise there to be achieved, within the flange surface region that is enclosed by the depression, thus within the residual contact region of the screw head. In some embodiments, the assembly opening has a first peripheral portion that is contiguous to a first flange surface region on the first flange side, and a second peripheral portion that in comparison to its first peripheral portion lies closer to the connector opening, a second flange surface region on the first flange side being contiguous to said second peripheral portion, wherein the first flange surface region and the second flange surface region on the external side thereof are bordered by the depression, wherein on the second flange side a periphery of the connector opening, and/or a surface region of the flange that is adjacent, in particular contiguous, to the connector opening, define(s) a geometric reference plane, and wherein the first flange surface region in comparison to the second flange surface region in a direction perpendicular to the reference plane is more remote from the latter.

The explanations pertaining to the reference plane relate to an initial state of the combination in which the combination is free of external forces that deform said combination, thus for example to a state prior to the assembly of the combination on another object such as, for example, a cylinder head housing of an engine. The reference plane mentioned herein is understood to be a geometric plane without any lateral delimitation. In some embodiments, the first flange surface region and the second flange surface region are mutually separated by only a step or an edge or an imaginary border line; this is however not necessary. Such a step or edge or imaginary border line is not a component part of said flange surface regions. For example, face part-regions of faces that lie on different sides of a step or edge or imaginary border line can also be considered as a first flange surface region and as a second flange surface region.

In some embodiments, the combination may comprise at least two screws, wherein in a use state in which in each case one screw, proceeding from the first flange side, is inserted into in each case one of the two assembly openings, on each screw, when viewed in a vertical projection of the screw head thereof onto the flange, the screw head thereof, in particular along the entire circumference thereof, projects radially outward beyond the inner periphery of the depression, and the outer periphery of the depression, in particular along the entire circumference thereof, runs radially outside the screw head. By means of the features described, the compressive stress can be comparatively reduced on that side of the screw head that is closer to the connector opening and comparatively increased on the side of the screw head that is opposite to the former.

In some embodiments, the collar may be inserted in the connector opening such that a collar longitudinal end of the collar on the second flange side in a direction perpendicular to the reference plane projects from the connector opening beyond said reference plane. This enables an axial offset, or a gap, respectively, between the second flange side and a housing (for example, a cylinder head housing of an engine) to which the combination is to be fastened. An end face of the collar longitudinal end can be specified as a, for example, circular annular functional face for support on a housing (for example, a cylinder head housing) chosen for fastening. There is the possibility for the collar to be press-fitted in the connector opening and/or to be welded to the flange, in particular by means of a laser welding method, or to be fastened in another way.

In some embodiments, there are dissimilar spacings between the first flange surface region and the reference plane, on the one hand, and the second flange surface region and the reference plane, on the other hand. The quantitative difference, in particular the largest quantitative difference, that arises between the spacing of the first flange surface region from the reference plane in a direction perpendicular to the latter, on the one hand, and the spacing of the second flange surface region from the reference plane in a direction perpendicular to the latter on the other hand may be smaller than or equal to the spacing of an end face of the collar longitudinal end and the reference plane in a direction perpendicular to the latter. In some embodiments, the first flange surface region and the second flange surface region extend so as to be parallel with the geometric reference plane.

In some embodiments, the first flange surface region may extend so as to be parallel with or inclined to the geometric reference plane, and for the second flange surface region, in particular configured so as to be planar or curved, to extend to as to be inclined to the geometric reference plane, wherein the spacing of the second flange surface region from the reference plane in a direction perpendicular to the latter, when viewed in a direction parallel to the direction of longitudinal extent, decreases as the distance from the connector opening decreases. For example, there is the possibility for a peripheral portion of the second flange surface region to run along a circular line.

In some embodiments, the surface of the flange on the second flange side, at least between the connector opening and the assembly opening or the assembly openings, may extend so as to be parallel to the reference plane. This relates to the initial state already discussed. This enables the use of conventional measuring means and prevents any undesirable change in the pre-tensioning.

In some embodiments, one clearance is configured in the flange between the connector opening and in each case one assembly opening. In some embodiments, the housing is a housing of a single-piston pump, the latter being in particular a high-pressure fuel pump (for example for gasoline or diesel fuel), or else a housing of a servo valve.

In some embodiments, an assembly comprises a combination which has individual or a plurality of the features described above, wherein the assembly comprises a housing, in particular a cylinder head housing of an engine, which has an in particular planar fastening surface for fastening the combination, wherein, proceeding from the fastening surface, an insertion opening and at least one first assembly bore extend into the housing, wherein the collar longitudinal end is supported on a region of the fastening surface that is adjacent to the insertion opening, wherein a screw is guided through the first assembly opening and the at least one assembly bore, wherein the flange is screw-fitted to the housing by means of the screw, and wherein the screw is tightened such that a first flange region in which the first assembly opening is configured contacts the fastening surface and in particular is compressed against the latter. In terms of possible refinements, effects, and advantages, reference is made to the description at large.

In some embodiments, proceeding from the fastening surface, at least one second assembly bore extends into the housing, that a second screw is guided through the second assembly opening and the second assembly bore, wherein the flange is screw-fitted to the housing by means of the second screw, and wherein the second screw is tightened such that a second flange region in which the second assembly opening is configured contacts the fastening surface and is compressed against the latter. In some embodiments, the screw or the screws has/have in each case one screw head, the respective contact region of the latter to the flange lying completely in a respective flange surface region of the flange that is formed collectively by the first flange surface region and the second flange surface region. In some embodiments, the housing may extend into the insertion opening of the housing.

A depression can be incorporated by means of embossing a circular annulus on the first flange side, for example. In some embodiments, the embossing may be performed in such a manner that said embossing likewise generates a circular annulus on the second flange side. On account thereof, the deformation can be established so as to be complete across the thickness of the flange.

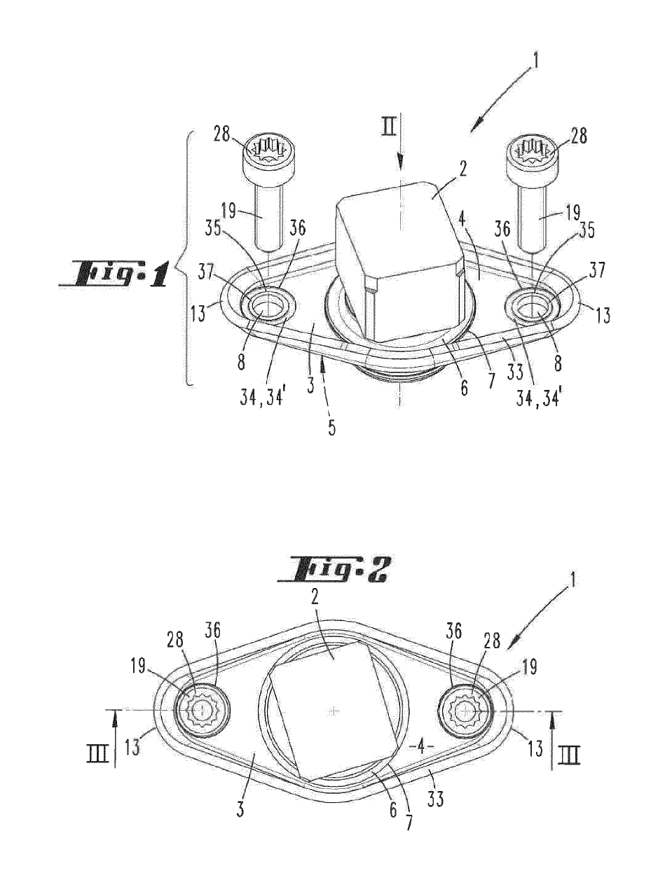

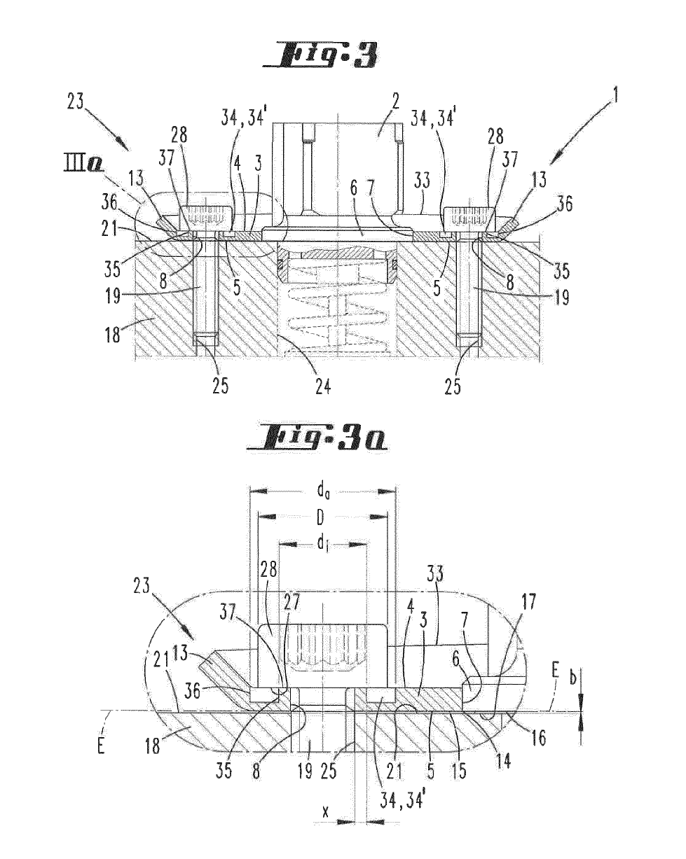

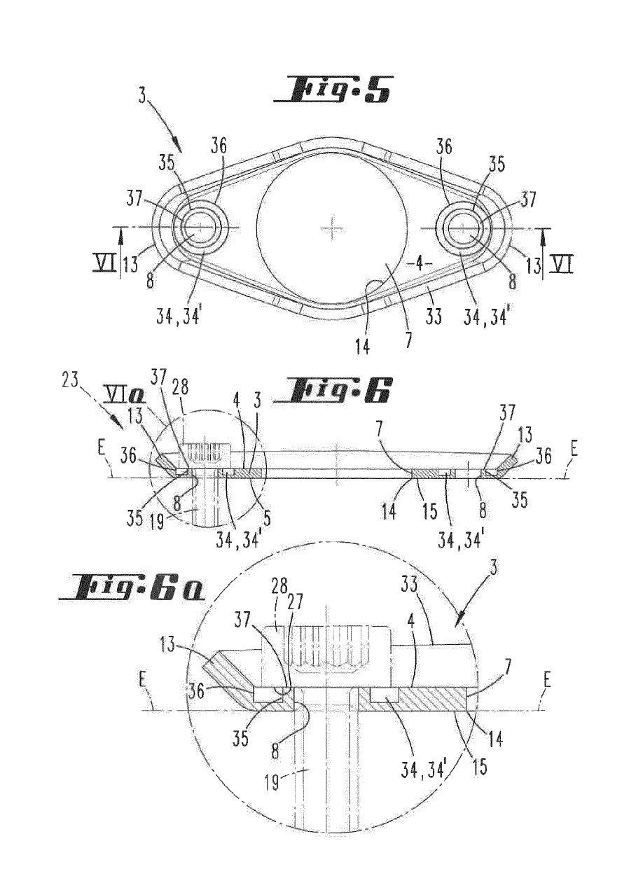

In some embodiments, a combination 1 incorporating teachings of the present disclosure, and according to a first exemplary embodiment, is described with reference to FIGS. 1 to 6a. The combination 1 comprises a housing 2 and a flange 3 which has a first flange side 4 that faces the housing 2, and opposite thereto a second flange side 5. A collar 6 which is inserted in a connector opening 7 of the flange 3 is configured on the housing 2. The collar 6 in the example is press-fit into the connector opening 7 by way of a press-fit and is additionally fastened to the flange 3 by means of laser-welded connection (not shown in more detail). Two assembly openings 8, the latter like the connector opening 7 being throughbores, are configured on the flange 3. The assembly openings 8 as well as details that are contiguous thereto or described in the context therewith, respectively, are referred to by the same reference signs for clarity.

Two depressions 34 of which in each case one depression 34 extends on the circumference in an uninterrupted manner about in each case one of the two assembly openings 8 are incorporated in the flange 3 on the first flange side 4. Each depression 34 has an inner periphery 35 and an outer periphery 36. The respective inner periphery 35 along the entire circumference thereof runs laterally so as to have a spacing x from the assembly opening 8. The depression 34 in the example is configured as a circular annular groove 34′, the groove width and groove depth of the latter being uniform along the entire circumference. For example, the groove depth can be in a range from 0.1 mm to 0.5 mm, e.g. 0.3 mm. These statements are exemplary.

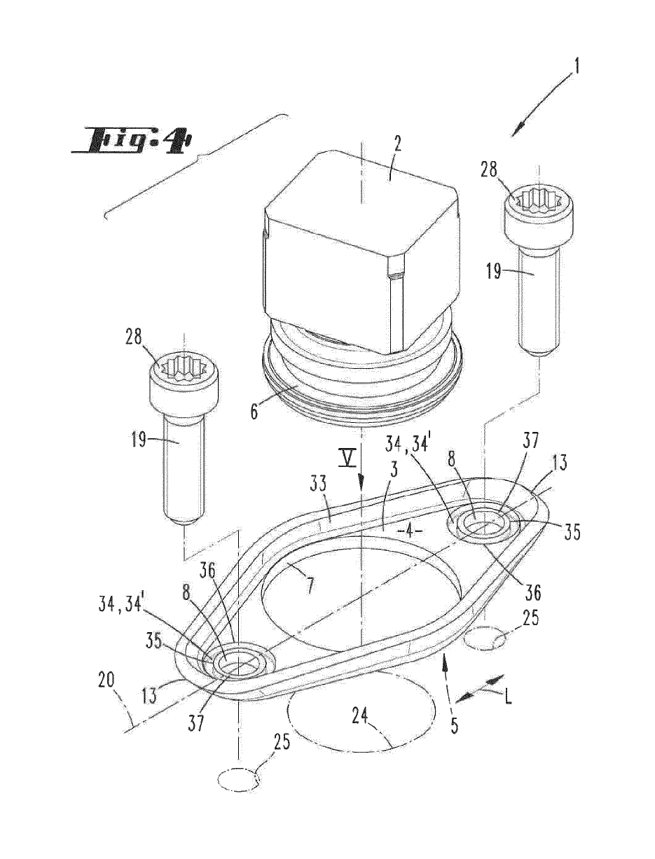

A respective circular annular flange surface region 37 is contiguous to the periphery of each assembly opening 8 on the first flange side 4, said flange surface region 37 extending in a planar manner along the entire circumference, for example. The combination 1 comprises two screws 19 of which in each case one can be plug-fitted through in each case one assembly opening 8, as is indicated in FIG. 4. Said screws 19 in the example are cylinder head screws. In the inserted state of the screws 19, in each case one circular annular flange surface region 37 forms one bearing face for the lower side 27 of a respective screw head 28. The inner periphery 35 and the outer periphery 36 in the example run along a respective circular line.

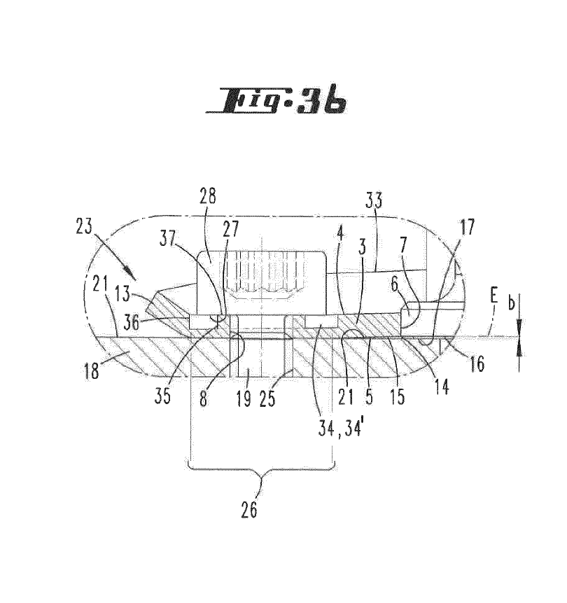

As is shown in FIG. 3a, the diameter D of the screw head 28 in the example is larger than the internal diameter d1 of the depression 34, but smaller than the external diameter da of the depression 34. The screw head 28 along the entire circumference thereof thus projects radially outward beyond the inner periphery 35 of the depression 34 without in the radial direction herein reaching outward beyond the depression 34. The shape and the size of the planar contact zone between the screw head 28 and the flange 3 is determined in this way. The radially outer peripheral region of the lower side 27 of the screw head 28 lies outside the chosen contact zone in which the compressive pressure acts when the screw 19 is tightened.

As is likewise shown in the enlargement of FIG. 3a, the collar 6 in the axial direction is inserted so far in the connector opening 7 that a collar longitudinal end 16 of the collar 6 on the second flange side 5 in a direction perpendicular to the reference plane E projects from the connector opening 7 beyond said reference plane E by a dimension b. In the non-deformed initial state, the geometric reference plane E that in the extent is not delimited on the second flange side 5 is defined by the periphery 14 of the connector opening 7 as well as by the surface region 15 of the flange 3, said surface region 15 there being contiguous to the connector opening 7. FIGS. 3, 3a herein show the combination 1 in conjunction with a fragment of a further housing 18 on which the combination 1 is to be assembled by means of the two screws 19.

According to FIG. 3a, the flange 3 in the non-deformed initial state is at least in regions configured so as to be planar on the second flange side 5. The fastening surface 21 of the housing 18 that faces the flange 3 also runs in a planar manner. The collar longitudinal end 16 by means of the end face 17 thereof is supported on the fastening surface 21. As a result, a gap having a uniform gap height is formed between the second flange side 5 and the housing 18 prior to the tightening of the screws 19 (cf. FIGS. 3, 3a). The gap height provides a pre-tensioning path in order for the flange 3 to be deformed when tightening the screws 19, in a manner comparable to that of a bending beam, so as on account thereof to be able to assemble the housing 2 on the housing 18 by way of pre-tensioning.

This pre-tensioning is intended to counteract any so-called “breathing” of the assembly when pressure variations arise in the interior of the housings 2, 18. FIG. 3b as a comparison shows a state after tightening the screws 19, wherein the contact region extends in the entire circular annular flange surface region 37, thus in the entire surface region between the inner periphery 35 and the outer periphery 36. As a result of the deformation of the flange, the contact pressure in a part-region of the flange surface region 37 that is closer to the housing 2 is higher than in a part-region of the flange surface region 37 that in comparison to the former is more remote from the housing 2. Were the depression 34 to be absent the highest contact pressure would be expected to be below the housing 2, in the region closest to the screw head outer periphery, since the largest “lever arm” would act thereon. The maximum “lever arm” is shortened by means of the depression 34, on account of which the maximum compression on the screw head 28 is also delimited or is comparatively decreased in relation thereto, respectively.

In the example, the connector opening 7 in terms of a direction of longitudinal extent L of the flange 3 is disposed so as to be centric between the two assembly openings 8, wherein the respective longitudinal central axes (indicated in FIG. 4) of the connector opening 7 and of the two assembly openings 8 collectively intersect a geometric longitudinal center line 20. 13 refers to two flange longitudinal ends, and 33 refers to an encircling reinforcement periphery on the flange 3. The housing 18 in the example is the housing of a single-piston pump.

FIGS. 3, 3a, 3b show an assembly 23 incorporating teachings of the present disclosure and according to an exemplary embodiment which in addition to the combination 1 comprises the housing 18 and the two screws 19 serving for assembly. Proceeding from the fastening surface 21 of the housing 18, an insertion opening 24 and two assembly bores uniformly referred to with the reference sign 25 extend into the housing 18, the internal threads of said assembly bores 25 matching the external thread of the screws 19. As has already been discussed, FIGS. 3, 3a show a state that arises during the assembly, in which the two screws are in each case guided through one assembly opening 8 and are initially loosely screwed into an assembly bore 25 aligned with said assembly bore 8, such that the parallel gap (shown enlarged in FIG. 3a) is maintained, the gap width of said gap corresponding to the dimension b.

FIG. 3b shows the final assembled state once the screws 19 have been screwed in so tightly that the flange 3 is deformed until a respective flange region 26 in which one of the assembly openings 8 is configured contacts the fastening surface 21 and is compressed against the latter. While FIGS. 3a, 3b show only an enlargement of detail IIIa from FIG. 3, the same situation arises at the second screw fitment point.

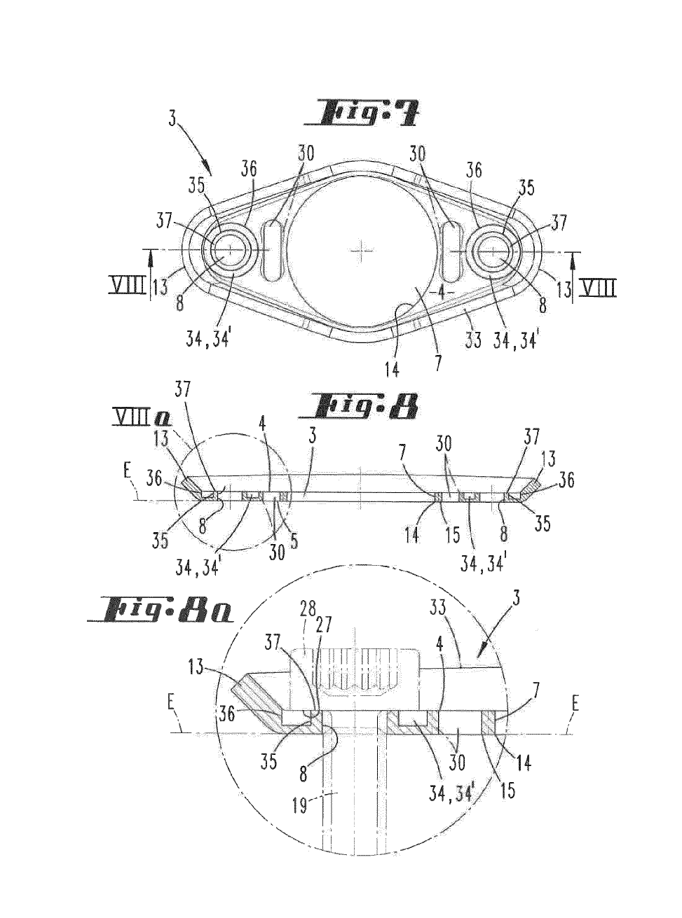

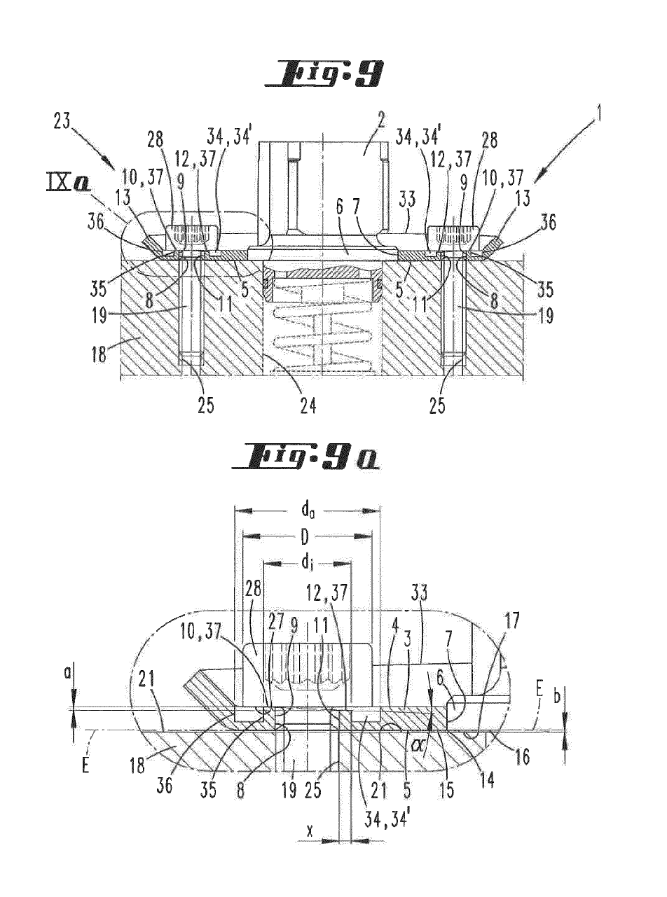

In the case of the description hereunder of further exemplary embodiments, for the sake of clarity details which are the same as in the preceding exemplary embodiment or similar thereto are referred to using the same reference signs. FIGS. 7, 8, and 8a show a design embodiment of a flange 3 for a combination 1 incorporating teachings of the present disclosure, as a potential alternative to FIGS. 1 to 6. The difference lies in that in each case one clearance 30 that continues through the flange 3 is configured between the connector opening 7 and in each case one assembly opening 8. The two clearances 30 in turn cause a targeted distribution of the contact pressure on the circular seat face of the pump housing. This serves for avoiding any tilting.

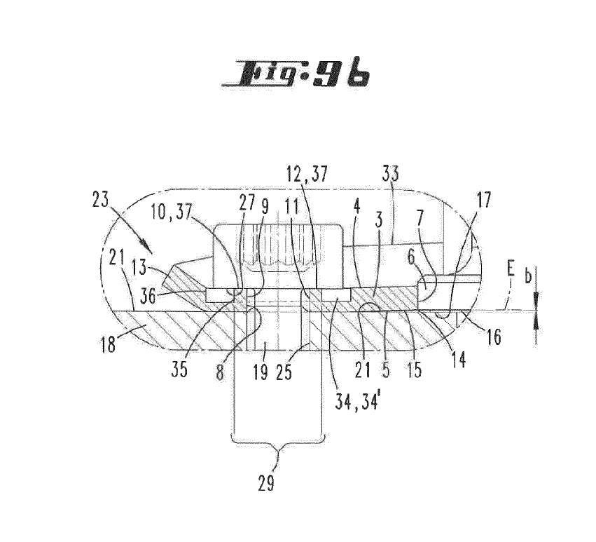

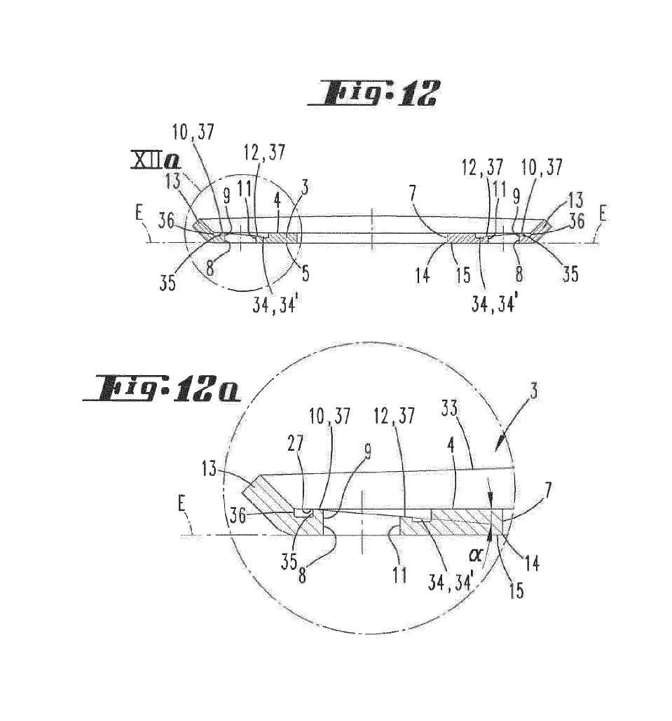

FIGS. 9 to 11a relate to a further exemplary embodiment of an assembly 23 incorporating teachings of the present disclosure, said assembly 23 comprising a combination 1 according to an example embodiment. Deviating from the preceding embodiments, the surface of the flange 3 in the latter between the inner periphery 35 of the depression 34 and the assembly opening 8 does not run at a uniform spacing from the reference plane E. Instead, in terms of each of the two assembly openings 8 it is provided that the circular annular flange surface region 37 is oriented so as to be inclined in relation to the reference plane E at an inclination angle α, cf. FIG. 11a, for example.

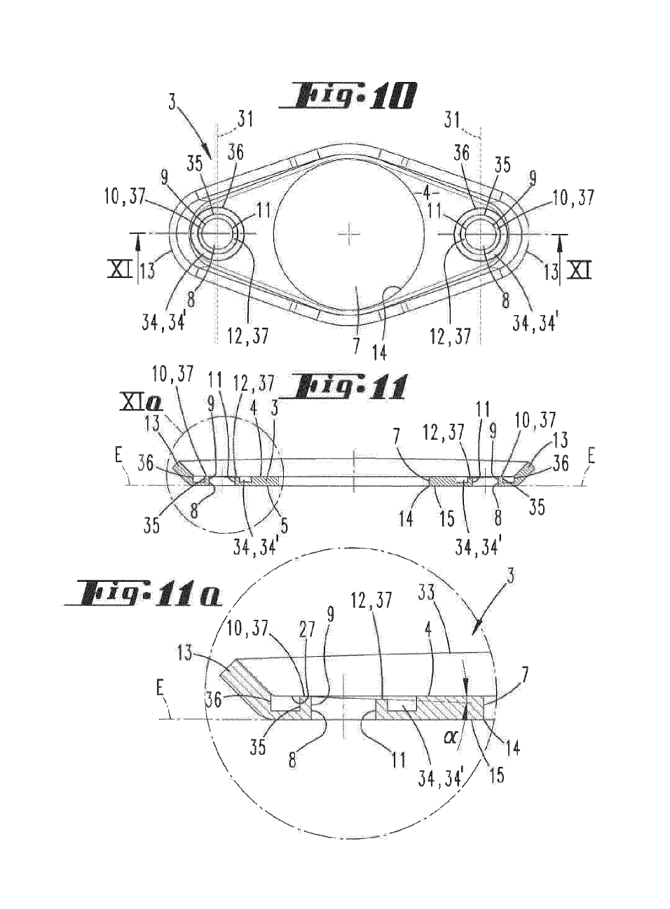

On account thereof, flange surface regions 10, 12 having dissimilar spacings from the reference plane E are created. To this extent, a respective assembly opening 8 comprises a first peripheral portion 9 to which a first flange surface region 10 is contiguous on the first flange side 4, and a second peripheral portion 11 which in comparison to the first peripheral portion 9 lies closer to the connector opening 7, wherein these two flange surface regions 10, 12 on the external side thereof are bordered by the depression 34, and wherein the first flange surface region 10 in comparison to the second flange surface region 12 in a direction perpendicular to the reference plane E is more remote from the latter. FIG. 10 indicates that the flange surface regions 10, 12 when viewed in a comparison can in each case lie at a circumferential interval that is symmetrical to the longitudinal center line 20, for example. An imaginary border line chosen in an exemplary manner is referred to with the reference sign 31 in FIG. 10, said border line being between the flange surface regions 10, 12 and not being part of any of the two flange surface regions 10, 12.

While the contact zone and, on account thereof, the maximum contact pressure that arises can be delimited by the depression 34, a dissimilar level of the two flange surface regions 10 and 12, as compared to a uniform level, enables a desired redistribution of the pressure that is created within the contact region when the screw is tightened. If the flange surface regions 10, 12 in FIG. 9a were to extend so as to be parallel with the reference plane E, this would result in a higher pressure being transmitted from the screw head 28 to the second flange surface region 12 than to the first flange surface region 10 after the screw has been tightened and the deformation of the flange caused on account thereof. This would result in an undesirable non-symmetrical loading of the screw head 28. This can be minimized or entirely avoided in that the angle α or the dimension a, respectively, is suitably adapted to the dimension b plotted in FIG. 9a, thus to the axial protrusion of the collar longitudinal end 16 and to the gap height resulting therefrom.

The figures are understood to be schematic, that is to say that the size ratios can deviate from the illustrations. In some embodiments, the largest quantitative difference, indicated by the dimension a, that arises between the spacing of the first flange surface region 10 from the reference plane E and that of the second flange surface region 12 from the reference plane E to be smaller than or equal to the spacing (dimension b) between the end face 16 of the collar longitudinal end 17 and the reference plane E.

The bearing region between the screw head 28 and the flange 3 is referenced by the reference sign 29 in FIG. 9b. Said bearing region extends in the entire circular annular region that lies between the inner periphery 35 and the assembly opening 8. However, depending on the chosen angle α or depending on the dimension a in relation to the dimension b, respectively, it could also be achieved that the bearing region 29 on the right side of the screw head in FIG. 9 does not reach fully up to the depression 34.

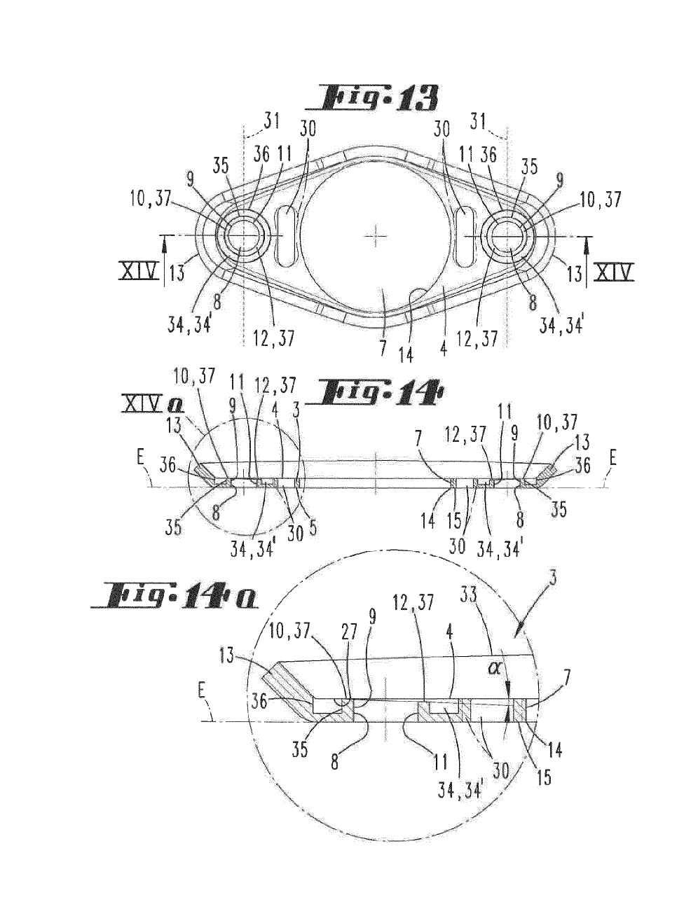

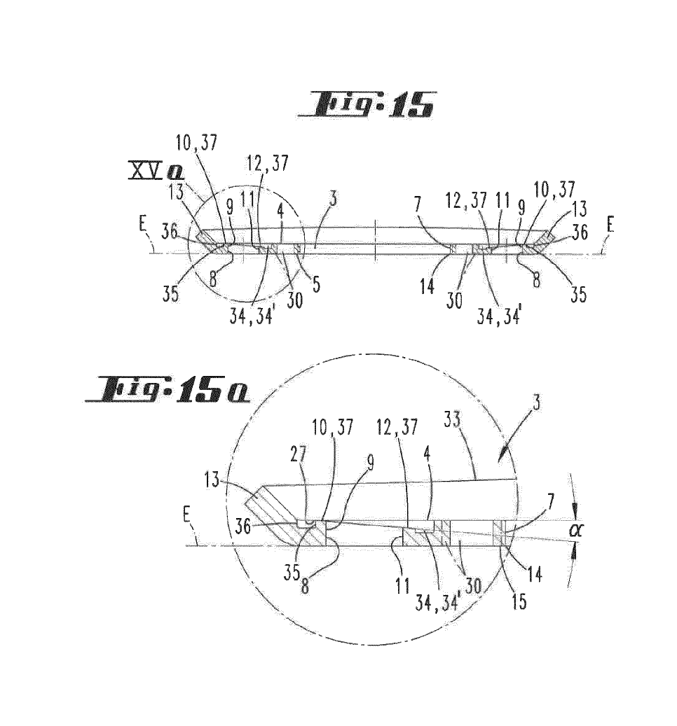

The variant of a flange 3 shown in FIGS. 12, 12a deviates from the flange 3 shown in FIGS. 9 to 11a in that a larger angle α has been chosen therein. The exemplary embodiment of a flange 3 shown in FIGS. 13, 14, and 14a deviates in that in each case one clearance 30 that continues through the flange 3 for the targeted distribution of the contact pressure on the circular seat face of the pump housing is configured between the connector opening 7 and each assembly opening 8, so as to avoid any tilting of the pump housing. A contour in the manner of an elongate hole is shown by way of a solid line, while the dashed line shows a potential modification. As is shown in FIGS. 15, 15a, this can also be combined with the angle α shown in FIGS. 12, 12a, for example.

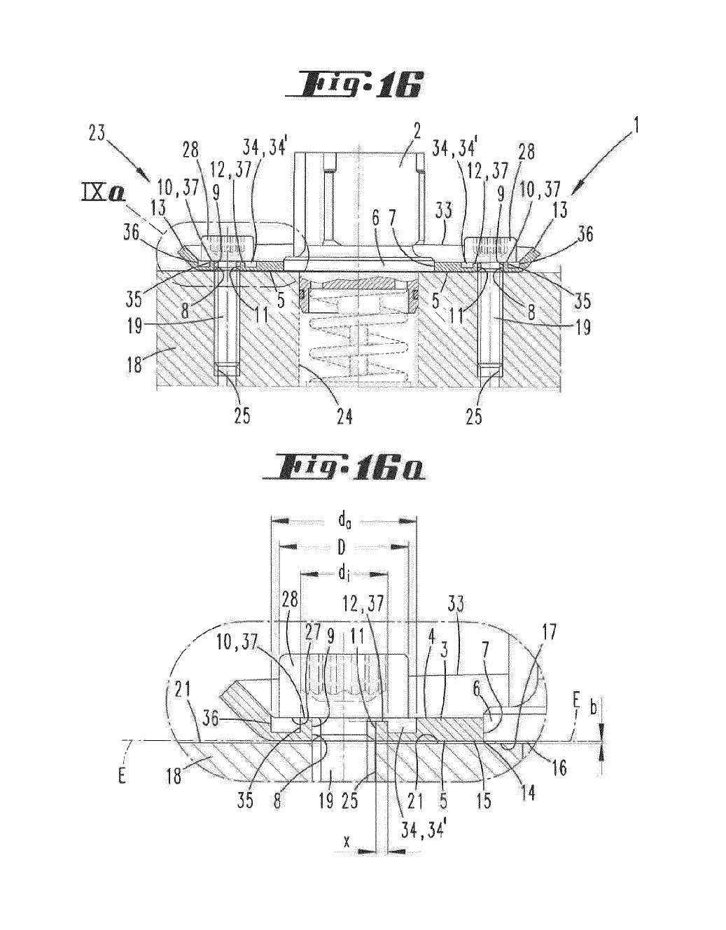

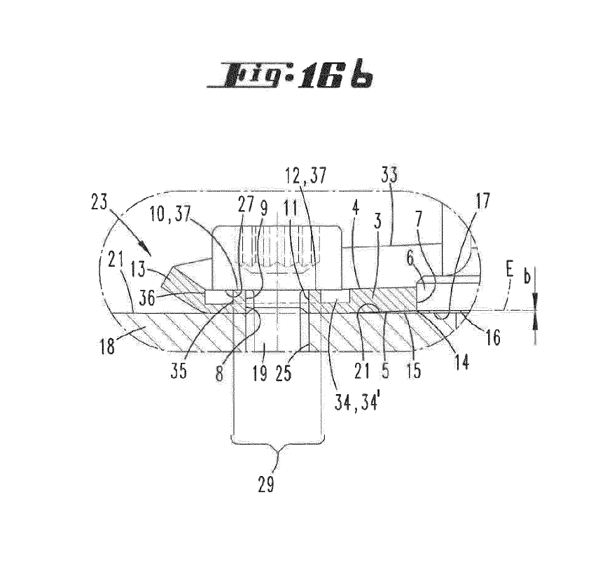

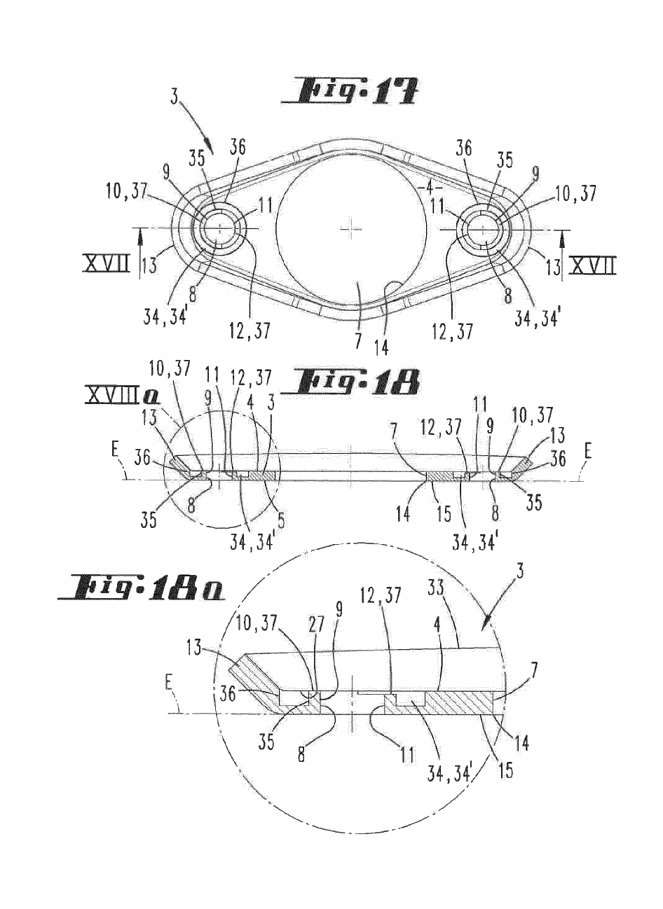

FIGS. 16 to 18a show a further exemplary embodiment of an assembly 23 which comprises a combination 1 incorporating teachings of the present disclosure and according to another exemplary embodiment. The first flange surface region 10 and the second flange surface region 12 herein extend in each case so as to be parallel with the geometric reference plane E, but at dissimilar spacings from the latter. The difference in terms of the height level achieved on account thereof can also be utilized in order to influence the distribution of pressure in the contact region between the screw head 28 and the flange 3 in a desired manner.

In the case of the exemplary embodiments shown in the figures, the assembly bores 25 are provided with a thread that matches the thread of the screws 19. In some embodiments, the assembly bores 25 to be without threads and for the screws 19 to be tightened by means of nuts.

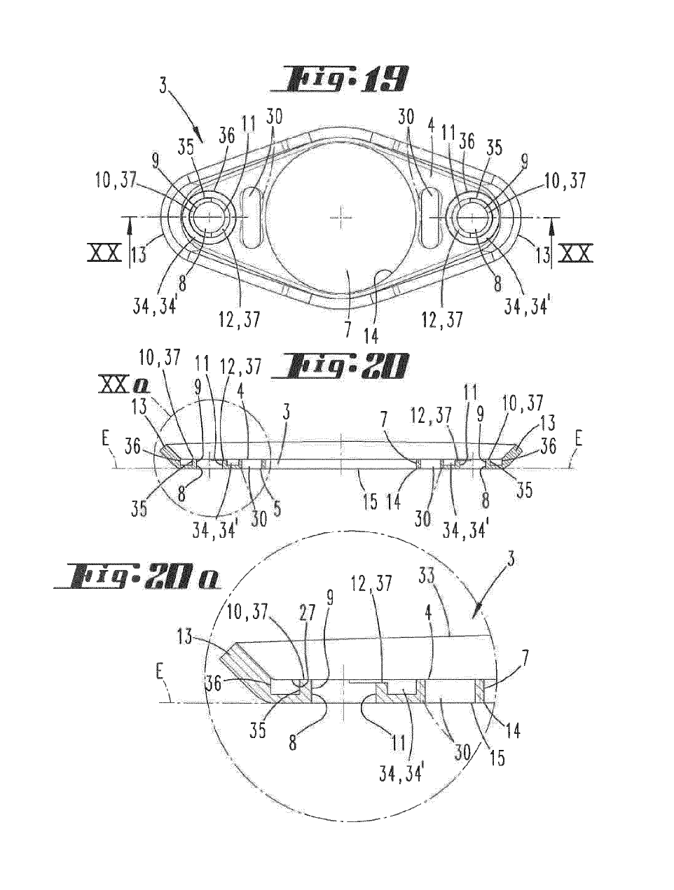

FIGS. 19, 20, and 20a show an alternatively possible design embodiment of a flange 3. The difference in relation to the flange 3 shown in FIGS. 16 to 18a is that in each case one clearance 30 that continues through the flange 3 is configured between the connector opening 7 and each assembly opening 8.

What is claimed is:

1. An assembly comprising:
a housing;
a flange having a first flange side and opposite thereto a second flange side;
a collar which either is part of the housing or is fastened to the housing;
wherein the collar extends into a connector opening of the flange;
the flange has a first assembly opening spaced from the connector opening; and
a depression running around the assembly opening on the first flange side;
wherein the depression includes an inner periphery running laterally along an entire circumference of the first flange side spaced from the assembly opening.

2. The assembly as claimed in claim 1, wherein:
the flange includes a second assembly opening spaced apart from the connector opening;
the connector opening is disposed between the first assembly opening and the second assembly opening; and
the first flange side includes a second depression running about the second assembly opening;
the second depression includes an inner periphery along the entire circumference of the second assembly opening spaced from the second assembly opening.

3. The assembly as claimed in claim 1, wherein the depression comprises an annular groove.

4. The assembly as claimed in claim 1, wherein a depth of the depression is uniform along the entire depression, and the depth is in the range from 0.1 mm to 0.5 mm.

5. The assembly as claimed in claim 1, wherein a width of the depression is uniform along the entire depression.

6. The assembly as claimed in claim 1, wherein:
the assembly opening has a first peripheral portion contiguous to a first flange surface region on the first flange side;
the assembly opening has a second peripheral portion lying closer in comparison to the first peripheral portion to the connector opening;
the first flange side comprises a second flange surface region contiguous to the second peripheral portion;
the first flange surface region and the second flange surface region on the external side thereof are bordered by the depression;
the second flange side includes a periphery of the connector opening and a surface region adjacent to the connector opening defining a geometric reference plane;
the first flange surface region is more remote in comparison to the second flange surface region in a direction perpendicular to the reference plane.

7. The assembly as claimed in claim 1, further comprising:
two screws;
wherein in a use state in which in each case one screw proceeding from the first flange side is inserted into in each case one of the two assembly openings;
on each screw, when viewed in a vertical projection of the screw head thereof onto the flange, a screw head projects radially outward beyond the inner periphery of the depression; and
the outer periphery of the depression runs radially outside the screw head.

8. The assembly as claimed in claim 2, wherein:
the connector opening is centered in terms of a direction of longitudinal extent of the flange between the first assembly opening and the second assembly opening; and
a respective longitudinal central axis of each of the connector opening, the first assembly opening, and the second assembly opening collectively intersect a geometric longitudinal center line.

9. The assembly as claimed in claim 6, wherein the collar extends into the connector opening such that a collar longitudinal end on the second flange side projects from the connector opening in a direction perpendicular to the reference plane beyond said reference plane.

10. The assembly as claimed in claim 1, wherein the collar is press-fitted into the connector opening and/or welded to the flange.

11. The assembly as claimed in claim 6, wherein a quantitative difference between a spacing of the first flange surface region from the reference plane in a direction perpendicular to the reference plane and the spacing of the second flange surface region from the reference plane in a direction perpendicular to the reference plane is smaller than or equal to a spacing of an end face of the collar longitudinal end and the reference plane in a direction perpendicular to the reference plane.

12. The assembly as claimed in claim 1, wherein the housing houses a single-piston pump or a servo valve.

13. The assembly as claimed in claim 6, wherein the first flange surface region and the second flange surface region extend so as to be parallel with the geometric reference plane.

14. The assembly as claimed in claim 1, wherein:
the first flange surface region extends parallel to or inclined to the geometric reference plane; and
the second flange surface region extends inclined to the geometric reference plane;
a spacing of the second flange surface region from the reference plane in a direction perpendicular to the reference plane, when viewed in a direction parallel to a direction of longitudinal extent, decreases as a distance from the connector opening decreases; and
a peripheral portion of the second flange surface region runs along a circle.

15. The assembly as claimed in claim 1, wherein a surface of the flange on the second flange side, at least between the connector opening and the assembly opening, extends parallel to the reference plane.

16. The assembly as claimed in claim 2, wherein the flange includes in each case one clearance between the connector opening and each assembly opening.

17. An assembly comprising:
a housing with a planar fastening surface;
a flange having a first flange side and opposite thereto a second flange side;
a collar which either is part of the housing or is fastened to the housing;
wherein the collar extends into a connector opening of the flange;
the flange has a first assembly opening spaced from the connector opening; and
a depression running around the assembly opening on the first flange side;
wherein the depression includes an inner periphery running laterally along an entire circumference of the first flange side spaced from the assembly opening;
proceeding from the fastening surface, an insertion opening and a first assembly bore extend into the housing;
the collar longitudinal end is supported on a region of the fastening surface adjacent to the insertion opening;
a screw extends through the first assembly opening and the assembly bore;
the flange is attached to the housing by the screw; and
the screw is tightened such that a first flange region of the first assembly opening contacts the fastening surface.

18. The assembly as claimed in claim 17, wherein:
proceeding from the fastening surface, a second assembly bore extends into the housing;
a second screw extends through the second assembly opening and the second assembly bore;
the flange is connected to the housing by the second screw; and
the second screw is tightened such that a second flange region of the second assembly opening contacts the fastening surface.

19. The assembly as claimed in claim 17, wherein the screw has one screw head with a contact region defined in contact with the flange, the contact region of the one screw head lying completely in a flange surface region of the flange defined by the first flange surface region and the second flange surface region.

20. The assembly as claimed in claim 17, wherein the housing protrudes into the insertion opening of the housing.
